(19) United States
(12) Patent Application Publication
(10) Pub. No.: US 2019/0119051 A1
(43) Pub. Date: Apr. 25, 2019

(54) Unloading System

(71) Applicants: Tyco Electronics (Shanghai) Co. Ltd., Shanghai (CN); TE Connectivity Corporation, Berwyn, PA (US); Kunshan League Automechanism Co., Ltd., Kunshan City (CN)

(72) Inventors: Yingcong Deng, Shanghai (CN); Dandan Zhang, Shanghai (CN); Lvhai Hu, Shanghai (CN); Fengchun Xie, Shanghai (CN); Yun Liu, Shanghai (CN); Haidong Wu, Kunshan City (CN); Hui Xiao, Kunshan City (CN); Roberto Francisco-Yi Lu, Bellevue, WA (US)

(73) Assignees: Tyco Electronics (Shanghai) Co. Ltd., Shanghai (CN); TE Connectivity Corporation, Berwyn, PA (US); Kunshan League Automechanism Co., Ltd., Kunshan City (CN)

(21) Appl. No.: 16/170,181

(22) Filed: Oct. 25, 2018

(30) Foreign Application Priority Data
Oct. 25, 2017 (CN) 201711011254.3

(51) Int. Cl. B65G 65/00; B65G 65/18

(52) U.S. Cl. CPC B65G 65/005; B65G 65/18; B65G 2203/044; B65G 2203/046; B65G 2203/042

(57) ABSTRACT

An unloading system comprises a rotatable table configured to be rotatable about a vertical axis parallel to a vertical direction, a plurality of fixing devices mounted on the rotatable table around a periphery of rotatable table and separated from each other, and a manipulator adapted to grip a product fixed on each of the fixing devices and move the gripped product to a predetermined position. The rotatable table is adapted to rotate the plurality of fixing devices mounted thereon into a work area of the manipulator one by one and the manipulator is adapted to unload the product from each of the fixing devices one by one.

### CROSS-REFERENCE TO RELATED APPLICATION

This application claims the benefit of the filing date under 35 U.S.C. § 119(a)-(d) of Chinese Patent Application No. 201711011254.3, filed on Oct. 25, 2017.

### FIELD OF THE INVENTION

The present invention relates to an unloading system and, more particularly, to an unloading system for a rotatable table.

### BACKGROUND

An assembly process of a product usually includes a number of steps and, in order to improve assembly efficiency, the product may be positioned on a rotatable table. The rotatable table rotates the product loaded on it to various assembly stations to complete the assembly of the product. After the product is assembled, the assembled product is rotated by the rotatable table to an unloading station where an operator unloads the assembled product from the rotatable table and visually checks whether the quality of the assembled product meets a qualification standard.

It is, however, inefficient to manually unload the assembled product from the rotatable table. Furthermore, visually inspecting the product for quality of assembly is not only inefficient but is also unreliable.

### SUMMARY

An unloading system comprises a rotatable table configured to be rotatable about a vertical axis parallel to a vertical direction, a plurality of fixing devices mounted on the rotatable table around a periphery of rotatable table and separated from each other, and a manipulator adapted to grip a product fixed on each of the fixing devices and move the gripped product to a predetermined position. The rotatable table is adapted to rotate the plurality of fixing devices mounted thereon into a work area of the manipulator one by one and the manipulator is adapted to unload the product from each of the fixing devices one by one.

### BRIEF DESCRIPTION OF THE DRAWINGS

The invention will now be described by way of example with reference to the accompanying Figures, of which:

FIG. 1 is a perspective view of an unloading system according to an embodiment; and

FIG. 2 is a perspective view of a manipulator, a sensor, and a fixture of the unloading system of FIG. 1.

### DETAILED DESCRIPTION OF THE EMBODIMENT(S)

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

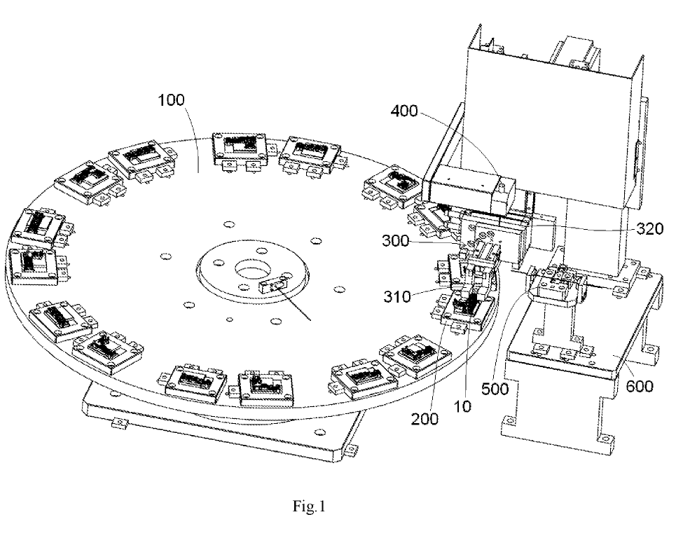

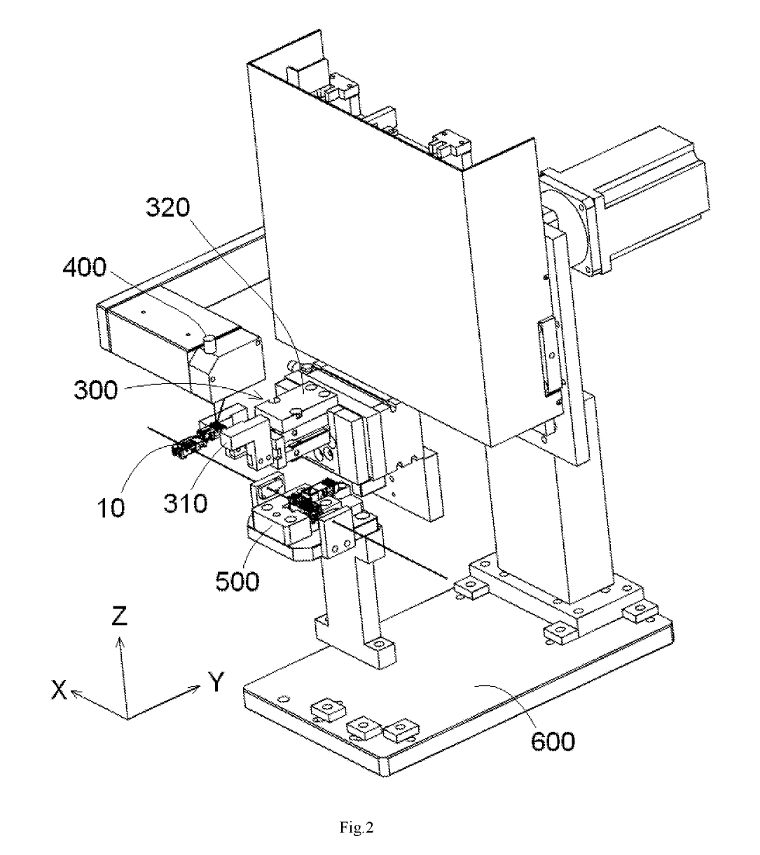

An unloading system according to an embodiment is shown in FIGS. 1 and 2. The unloading system comprises a rotatable table 100, a plurality of fixing devices 200, and a manipulator 300. The rotatable table 100 is configured to be rotatable about a vertical axis parallel to a vertical direction Z. The plurality of fixing devices 200 are mounted on the rotatable table 100, arranged around the periphery of rotatable table 100, and separated from each other. The manipulator 300 is adapted to grip a product 10 fixed on the fixing device 200 and move the gripped product 10 to a predetermined position.

The rotatable table 100, shown in FIGS. 1 and 2, is adapted to rotate the plurality of fixing devices 200 mounted thereon into a work area of the manipulator 300 one by one. The manipulator 300 unloads the products 10 from the plurality of fixing devices 200 on the rotatable table 100 one by one, improving efficiency of unloading the product 10 from the rotatable table 100.

The manipulator 300, shown in FIGS. 1 and 2, is also adapted to rotate the gripped product 10 to a predetermined pose for subsequent operations of the product 10. The manipulator 300 is adapted to move the product 10 in a first horizontal direction X and the vertical direction Z. The manipulator 300 is also adapted to rotate the product 10 about a horizontal axis parallel to a second horizontal direction Y perpendicular to the first horizontal direction X. The manipulator 300 includes a moving mechanism 320 and a gripper 310 mounted on the moving mechanism 320. The gripper 310 is adapted to grip the product 10 and the moving mechanism 320 is adapted to move and rotate the gripper 310.

The unloading system, as shown in FIGS. 1 and 2, comprises a sensor 400 adapted to detect whether the product 10 is qualified. In order to detect the quality of the product 10, the manipulator 300 is adapted to move the product 10 to a position below the sensor 400, so that a part of the product 10 to be detected is located under the sensor 400 and faces the sensor 400. The manipulator 300 is mounted on a fixation frame and the sensor 400 is fixed on the fixation frame; the sensor 400 does not move with the manipulator 300. In various embodiments, different types of sensors 400 may be selected depending on the detection tasks. For example, the sensor 400 may comprise a non-contact distance sensor, a visual sensor, or an infrared sensor.

The product 10 to be detected may comprise a connector including a housing and a contact inserted into the housing. In an embodiment, the sensor 400 is a non-contact distance sensor for detecting whether a depth of insertion of the contact into the housing is equal to a predetermined depth. In an embodiment, a plurality of contacts are inserted into the housing, and the manipulator 300 is adapted to move the plurality of contacts one by one to a position below the sensor 400, so as to detect whether the depth of each contact inserted into the housing is equal to the predetermined depth.

In another embodiment, the sensor 400 is a visual sensor for detecting whether an external appearance of the product 10 meets a predetermined requirement. For example, the sensor 400 may comprise a camera. The product 10 may have a plurality of external appearance areas to be detected, and the manipulator 300 is adapted to move the plurality of external appearance areas of the product 10 one by one to a position below the sensor 400, so as to detect whether each external appearance area of the product 10 meets the predetermined requirement.

The unloading system, as shown in FIGS. 1 and 2, comprises a fixture 500 adapted to fix the product 10. The manipulator 300 is adapted to place the product 10 that has been detected by the sensor 400 on the fixture 500. Then, a robot (not shown) may remove the product 10 from the fixture 500 for the next procedure; for example, the robot may assemble the qualified product 10 onto a circuit board, or discard the unqualified product into a waste recycling box.

The unloading system as shown in FIGS. 1 and 2, comprises a support base 600. The manipulator 300 and the fixture 500 are mounted and supported on the support base 600.

What is claimed is:

1. An unloading system, comprising:
a rotatable table configured to be rotatable about a vertical axis parallel to a vertical direction;
a plurality of fixing devices mounted on the rotatable table around a periphery of rotatable table and separated from each other; and
a manipulator adapted to grip a product fixed on each of the fixing devices and move the gripped product to a predetermined position, the rotatable table is adapted to rotate the plurality of fixing devices mounted thereon into a work area of the manipulator one by one and the manipulator is adapted to unload the product from each of the fixing devices one by one.

2. The unloading system of claim 1, wherein the manipulator is adapted to rotate the product to a predetermined pose.

3. The unloading system of claim 2, wherein the manipulator is adapted to move the product in a first horizontal direction and the vertical direction.

4. The unloading system of claim 3, wherein the manipulator is adapted to rotate the product about a horizontal axis parallel to a second horizontal direction perpendicular to the first horizontal direction.

5. The unloading system of claim 2, wherein the manipulator includes a moving mechanism and a gripper mounted on the moving mechanism.

6. The unloading system of claim 5, wherein the gripper is adapted to grip the product and the moving mechanism is adapted to move and rotate the gripper.

7. The unloading system of claim 2, further comprising a sensor adapted to detect whether the product is qualified.

8. The unloading system of claim 7, wherein the manipulator is adapted to move the product to a position below the sensor so that a part of the product to be detected is located under the sensor and faces the sensor.

9. The unloading system of claim 8, wherein the manipulator is mounted on a fixation frame and the sensor is fixed on the fixation frame and does not move with the manipulator.

10. The unloading system of claim 7, wherein the sensor is a non-contact distance sensor, a visual sensor, or an infrared sensor.

11. The unloading system of claim 7, wherein the product is a connector including a housing and a contact inserted into the housing, and the sensor is a non-contact distance sensor adapted to detect whether a depth of insertion of the contact into the housing is equal to a predetermined depth.

12. The unloading system of claim 11, wherein a plurality of contacts are inserted into the housing and the manipulator is adapted to move each of the plurality of contacts one by one to a position below the sensor to detect whether the depth of insertion of each contact into the housing is equal to the predetermined depth.

13. The unloading system of claim 7, wherein the sensor is a visual sensor adapted to detect whether an external appearance of the product meets a predetermined requirement.

14. The unloading system of claim 13, wherein the product has a plurality of external appearance areas to be detected and the manipulator is adapted to move each of the plurality of external appearance areas of the product one by one to a position below the sensor to detect whether each external appearance area of the product meets the predetermined requirement.

15. The unloading system of claim 7, further comprising a fixture adapted to fix the product, the manipulator is adapted to place the product that has been detected by the sensor on the fixture.

16. The unloading system of claim 15, further comprising a support base on which the manipulator and the fixture are mounted and supported.
